(19) United States
(12) Patent Application Publication
(10) Pub. No.: US 2015/0224003 A1
(43) Pub. Date: Aug. 13, 2015

(54) CARRYING APPARATUS FOR WHEELCHAIRS

(71) Applicants: Richard Robert ALLEN, Sunrise, FL (US); Scott Charles Leikala, Sunrise, FL (US)

(72) Inventors: Richard Robert ALLEN, Sunrise, FL (US); Scott Charles Leikala, Sunrise, FL (US)

(21) Appl. No.: 14/180,122

(22) Filed: Feb. 13, 2014

(51) Int. Cl. A61G 5/10

(52) U.S. Cl. CPC A61G 5/10

(57) ABSTRACT

A carrying apparatus is provided. The carrying apparatus may include a rear panel and a seat panel having horizontal straps forming a plurality of uniformly spaced loop openings. A user may releasably attach the rear panel and or the seat panel to a wheelchair. The user may then attach a wide variety of equipment to the loop openings so as to maximize ease of access to the equipment as well as prevent the pendulum effect.

### BACKGROUND OF THE INVENTION

The present invention relates to the storage and transportation of articles and, more particularly, to an apparatus for storing and carrying articles on a wheelchair.

Wheelchair users, especially new users, typically lose items as the items tend to fall out of or between elements of the wheelchair. Moreover, users may end up sitting on the items, causing sores or other injuries. Unfortunately, common devices used for carrying items, for example, tote bags and backpacks, can injure the user and damage the wheelchair as a result of the pendulum effect induced by a wheelchair's particular herky-jerky motion.

As can be seen, there is a need for an apparatus for carrying articles when using a wheelchair such that the items won't get lost or sat on, and that is not susceptible to the pendulum effect.

### SUMMARY OF THE INVENTION

In one aspect of the present invention, a carrying apparatus comprises: a wheelchair comprising a back having an inner back and an outer back; and a plurality of parallel substantially horizontal straps integrated to the outer back at predetermined attachment points forming a plurality of attachment loops.

In another aspect of the present invention, a carrying apparatus comprises: a wheelchair comprising a back having an inner back and an outer back; a backing sheet releasably attached to the outer back, wherein the plurality of parallel substantially horizontal straps are integrated to the backing sheet at predetermined attachment points forming a plurality of attachment loops.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a perspective view of an exemplary embodiment of the present invention in use;

FIG. 3 is a sectional detail view of an exemplary embodiment of the present invention along line 3-3 in FIG. 2;

FIG. 4 is an exploded view of an exemplary embodiment of the present invention in use;

FIG. 5 is an detailed view of an exemplary embodiment of the present invention; and

FIG. 6 is a detailed view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a carrying apparatus for wheelchairs. The carrying apparatus may include a rear panel and a seat panel having horizontal straps forming a plurality of uniformly spaced loop openings. A user may attach the rear panel and or the seat panel to a wheelchair. The user may then attach a wide variety of equipment to the loop openings so as to maximize ease of access to the equipment as well as prevent the pendulum effect.

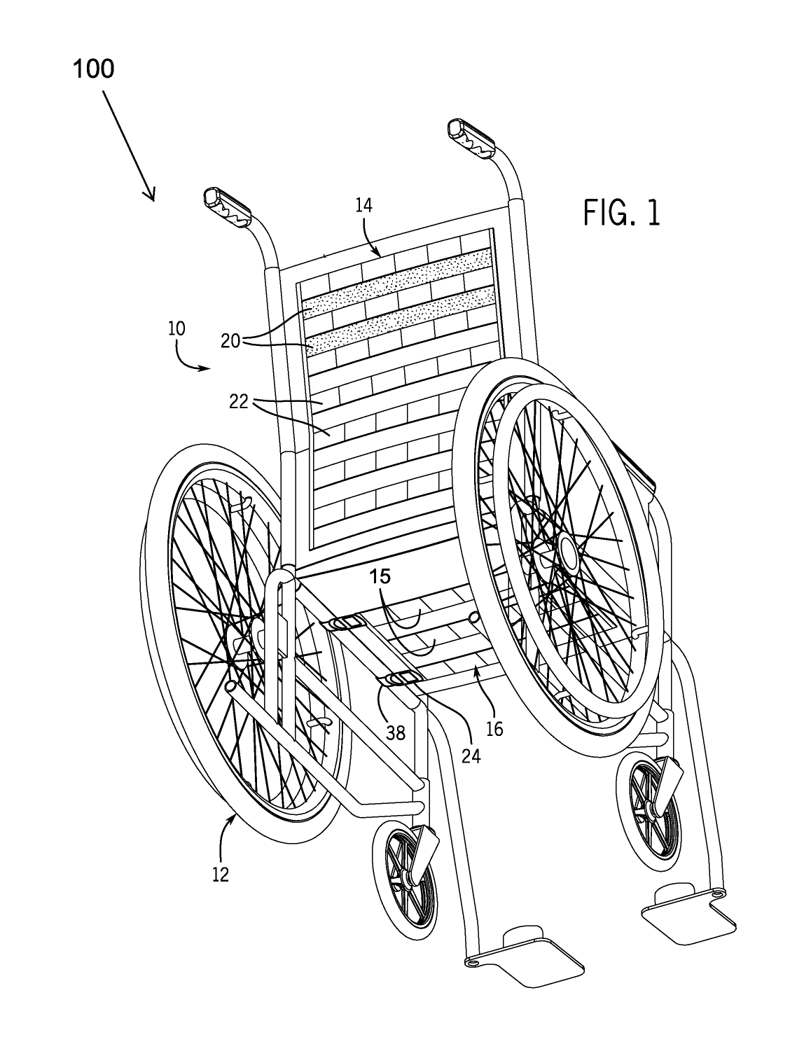

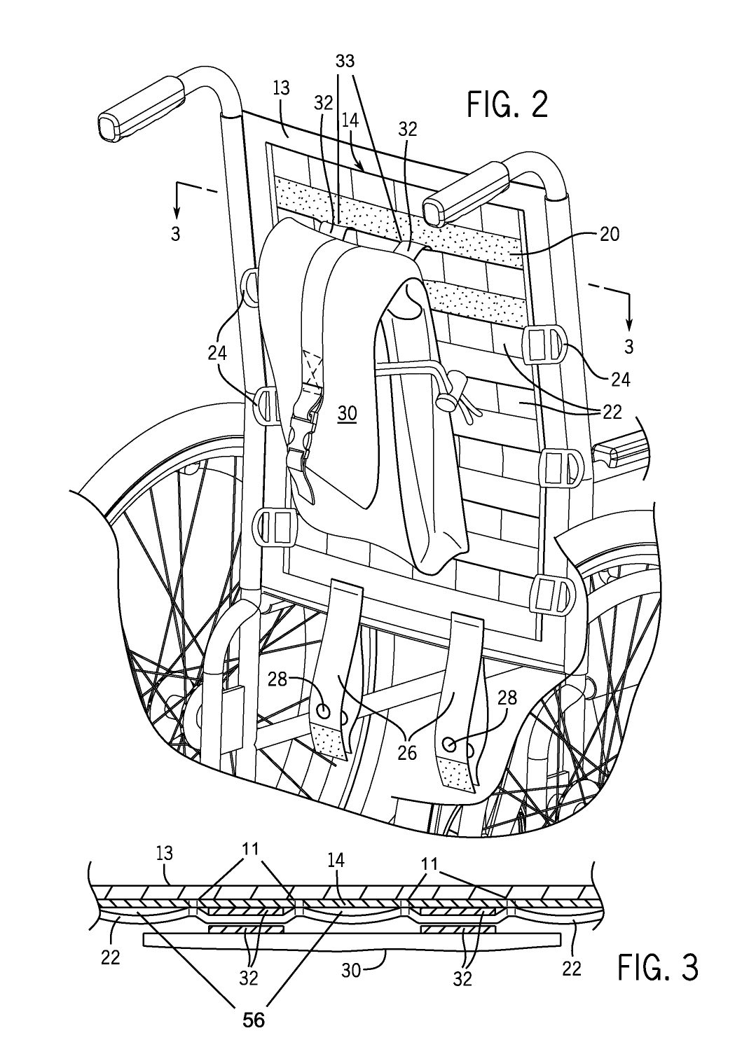

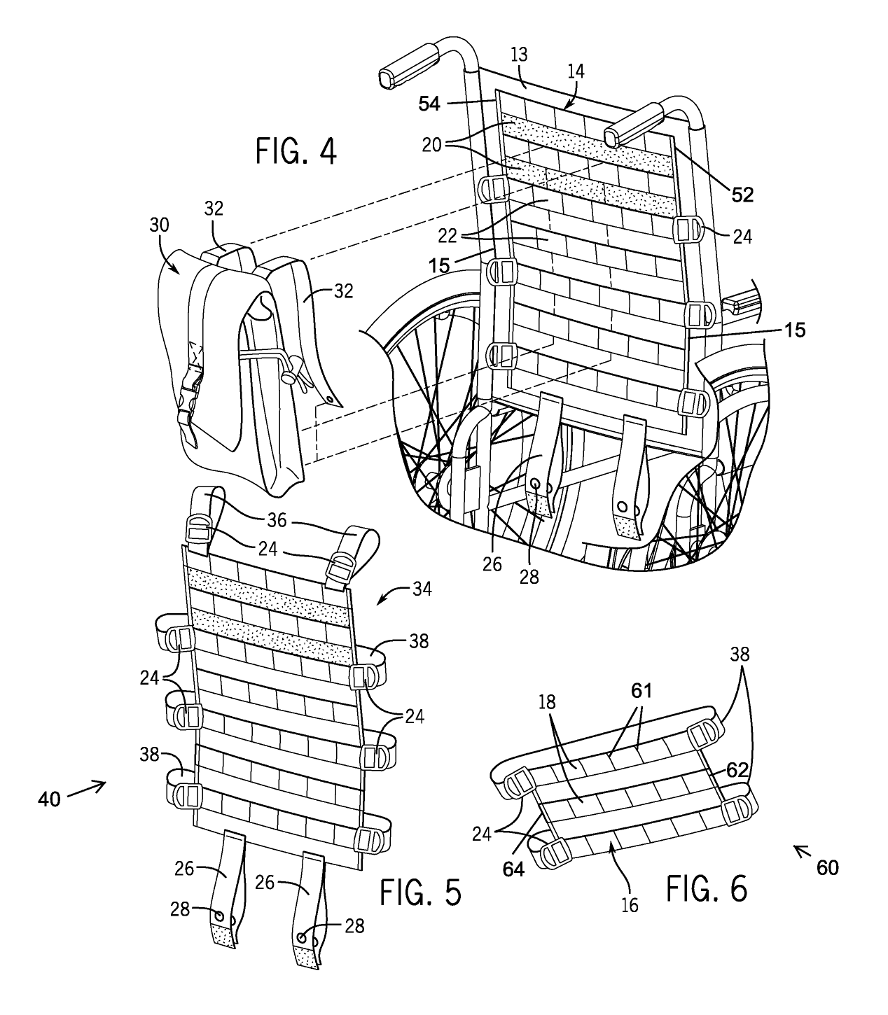

Referring to FIGS. 1 through 6, the present invention may include a carrying apparatus 100. The carrying apparatus 100 may include a rear panel 40 and a seat panel 60.

The rear panel 40 may include a plurality of horizontal straps 22 having a plurality of attachment points 11 and a backing sheet 14. The plurality of horizontal straps 22 may be parallel and uniformly spaced along the backing sheet 14. Each of the plurality of horizontal straps 22 may include a first end 52 and a second end 54. The plurality of attachment points 11 may attach a plurality of portions of the horizontal straps 22 to the backing sheet 14 in between the first end 52 and the second end 54 forming a plurality of uniformly spaced loop openings 56. The plurality of attachment points 11 may include, but not be limited to, stitching using bonded nylon thread.

The rear panel 40 may have a plurality of connectors for releasably attaching the rear panel 40 to an object, such as but not limited to, a wheelchair 12. The plurality of connectors may include devices known in the art for attaching or removably securing one object to another including, such as for example, vertically-oriented straps 36 and or horizontally-oriented straps 38 with buckles 24, straps 26 with push-button snaps 28, velcro-type fasteners, adhesive substances, combinations thereof, and the like.

The wheelchair 12 may include a back and a seat. The back may include an inner back adapted to support the wheelchair user's back and an outer back 13. The seat may include an inner seat adapted to support the wheelchair user's seat and an outer seat 15.

The plurality of uniformly spaced loop openings 56 may be configured to organize, transport and store of a wide variety of equipment 30, including, but not limited to, equipment 30 that may be MOLLE compatible. The plurality of uniformly spaced loop openings 56 may be configured to prevent the equipment 30 from causing repetitive strain injuries and damage to the wheelchair 12 due to a pendulum effect. The pendulum effect may include the swinging of the equipment 30 induced by the particular herky-jerky motion of the wheelchair 12. For example, the equipment 30 may be hung from the plurality of uniformly spaced loop openings 56 so as to have multiple secured points 33 so that the equipment 30 may not swing.

In certain embodiments, the plurality of horizontal straps 22 may be integrated into the outer back 13, wherein the plurality of attachment points 11 may attach a plurality of portions of the horizontal straps 22 to the outer back 13 in between the first end 52 and the second end 54 forming a plurality of uniformly spaced loop openings 56.

In certain embodiments, a portion of the carrying apparatus 100 may include a plurality of equipment fastening elements, such as but not limited to, hook and loop fasteners 20 in between the plurality of horizontal straps 22.

The seat panel 60 may include a plurality of horizontal straps 18 and a seat-backing sheet 16. The plurality of horizontal straps 18 may be parallel and uniformly spaced along the seat-backing sheet 16. Each of the plurality of horizontal straps 18 may include a first end 62 and a second end 64. The plurality of attachment points 61 may attach a plurality of portions of the horizontal straps 18 to the seat-backing sheet 16 in between the first end 62 and the second end 64 forming a plurality of uniformly spaced loop openings. The plurality of attachment points 61 may include, but not be limited to, stitching using bonded nylon thread.

The seat panel 60 may have a plurality of connectors for releasably attaching the seat panel 60 to the wheelchair 12. The plurality of connectors may include devices known in the art for attaching or removably securing one object to another including, such as for example, vertically-oriented straps and or horizontally-oriented straps 38 with buckles 24, straps with push-button snaps, velcro-type fasteners, adhesive substances, combinations thereof, and the like.

In certain embodiments, the plurality of horizontal straps 18 may be integrated into the outer seat 15, wherein the plurality of attachment points 61 may attach a portion of the horizontal straps 18 to the outer seat 15 in between the first end 52 and the second end 54 forming a plurality of uniformly spaced loop openings 56.

The rear panel 40 and seat panel 60 may be made of high strength material such as Kevlar, carbon fiber, polyester, polypropylene, nylon, polymers and the like.

A method of using the present invention may include the following. The carrying apparatus 100 disclosed above may be provided. A user may attach the rear panel 40 and or the seat panel 60 to the wheelchair 12. The user may then attach a wide variety of equipment 30 to the plurality of loop openings 56 so as to maximize ease of access to the equipment 30 as well as prevent the pendulum effect. In certain embodiments, the equipment will be supported within at least one loop openings 56 by straps 32.

It should be understood, of course, that the foregoing relates to exemplary embodiments of the invention and that modifications may be made without departing from the spirit and scope of the invention as set forth in the following claims.

What is claimed is:

1. A carrying apparatus comprising:
a wheelchair comprising a back having an inner back and an outer back; and
a plurality of parallel substantially horizontal straps integrated to the outer back at predetermined attachment points forming a plurality of attachment loops.

2. The carrying apparatus of claim 1, wherein the attachment points comprise stitching.

3. The carrying apparatus of claim 1, further comprising a backing sheet releasably attached to the outer back, wherein the plurality of parallel substantially horizontal straps are integrated to the backing sheet at predetermined attachment points forming a plurality of attachment loops.

4. The carrying apparatus of claim 1, wherein the wheelchair further comprises a seat having an inner seat and an outer seat, wherein a plurality of parallel substantially horizontal straps are integrated to the outer seat at predetermined attachment points forming a plurality of attachment loops.

5. The carrying apparatus of claim 4, further comprising a seat-backing sheet releasably attached to the outer back, wherein the plurality of parallel substantially horizontal straps are integrated to the backing sheet at predetermined attachment points forming a plurality of attachment loops.

6. A carrying apparatus comprising:
a wheelchair comprising:
a back having an inner back and an outer back; and
a seat having an inner seat and an outer seat;
a plurality of parallel substantially horizontal straps integrated to the outer back at predetermined attachment points forming a plurality of attachment loops; and
a plurality of parallel substantially horizontal straps integrated to the outer seat at predetermined attachment points forming a plurality of attachment loops.

7. The carrying apparatus of claim 6, wherein the attachment points comprise stitching.

8. The carrying apparatus of claim 6, further comprising further comprising:
a backing sheet releasably attached to the outer back, wherein the plurality of parallel substantially horizontal straps integrated to the backing sheet at predetermined attachment points forming a plurality of attachment loops; and
a seat-backing sheet releasably attached to the outer seat, wherein the plurality of parallel substantially horizontal straps are integrated to the seat-backing sheet at predetermined attachment points forming a plurality of attachment loops.

9. A method of preventing the pendulum effect, comprising:
providing a carrying apparatus comprising: a wheelchair comprising a back having an inner back and an outer back; and a plurality of parallel substantially horizontal straps attached to the outer back at predetermined attachment points forming a plurality of attachment loops.
securing at least one article to the plurality of attachment loops; and
using the wheelchair as a means of transportation.

10. The method of claim 9 further comprising the step of:
providing a backing sheet releasably attached to the outer back, wherein the plurality of parallel substantially horizontal straps integrated to the backing sheet at predetermined attachment points forming a plurality of attachment loops
